(19) United States
(12) Patent Application Publication
(10) Pub. No.: US 2026/0104706 A1
(43) Pub. Date: Apr. 16, 2026

(54) NAVIGATION DEVICE AND METHOD BASED ON MULTIMODAL INFORMATION

(71) Applicant: ELECTRONICS AND TELECOMMUNICATIONS RESEARCH INSTITUTE, Daejeon (KR)

(72) Inventors: Seung Min Choi, Daejeon (KR); Beom-Su Seo, Daejeon (KR); Jae-Yeong Lee, Daejeon (KR)

(21) Appl. No.: 19/347,810

(22) Filed: Oct. 2, 2025

(30) Foreign Application Priority Data
Oct. 10, 2024 (KR) 10-2024-0137637
Sep. 23, 2025 (KR) 10-2025-0136951

(51) Int. Cl. G05D 1/246; G01C 21/00; G01C 21/36; G05D 101/15; G05D 105/30; G05D 111/10; G06V 10/44; G06V 10/82; G06V 20/56; G10L 15/22

(52) U.S. Cl. CPC G05D 1/2462; G01C 21/3647; G01C 21/3815; G06V 10/44; G06V 10/82; G06V 20/588; G10L 15/22; G05D 2101/15; G05D 2105/315; G05D 2111/10

(57) ABSTRACT

A navigation device and method based on multimodal information are provided. The navigation device includes a storage device configured to store a plurality of waypoint images and a plurality of first movement reference instructions previously generated by using a database, a memory and a processor. The navigation method includes a step of receiving an observed image, a step of extracting a goal image from among the plurality of waypoint images stored in the database and extracting a second movement reference instruction applied to autonomous driving of a robot from among the plurality of first movement reference instructions stored in the database, based on the observed image, and a step of inputting the observed image, the goal image, and the second movement reference instruction to a pre-trained autonomous driving path generation model to generate an autonomous driving path and motion to be applied to the robot.

### CROSS-REFERENCE TO RELATED APPLICATIONS

This application claims priority under 35 U.S.C. § 119 to Korean Patent Application Nos. 10-2024-0137637, filed on Oct. 10, 2024, and 10-2025-0136951, Sep. 23, 2025, the disclosure of which is incorporated herein by reference in its entirety.

### BACKGROUND

### 1. Field of the Invention

The present disclosure relates to robotics and vehicle navigation technology. In detail, the present disclosure relates to a device and a method, which may automatically generate an autonomous driving path of a robot by using an artificial intelligence model, based on multimodal information.

### 2. Description of Related Art

Blind persons capable of using a guide dog are few. First reason is because it is difficult to breed guide dogs, and due to this, a considerable expense is consumed, and the second reason is because only blind persons having a sense of direction may be rehomed with a guide dog. In detail, because guide dogs may not remember all roads, only blind persons having an ability (orientation) to determine an approximate current position and a map memorized in a head may be rehomed with a guide dog. In 2023, only about 80 guide dogs are being managed domestically.

Moreover, robot self-driving technology is capable of driving with the precision of a considerable level in a closed space, such as home, offices, and commercial stores, or an autonomous delivery model zone, and thus, has entered a commercialization step. Therefore, in a case where a guide dog is replaced with a robot capable of autonomous driving, the mobility of blind persons may be enhanced.

However, it is difficult to automate an operation of writing a precision map in a wide indoor space such as subway and shopping malls or an outdoor environment which is radially opened, and thus, a person should directly participate in a mapping process and perform a considerable correction operation. That is, an operation of precisely mapping whole city needs the astronomical cost, and this is a large obstacle to activating a self-driving robot service in city as well as a guide dog robot which helps the movement of a blind person.

Therefore, autonomous driving (particularly, self-driving technology requiring no precise map) of a guide dog robot is needed.

In the related art, self-driving technology which does not use a precise map has the following two examples.

### (1) Visual Teach and Repeat (ClearPath)

https://clearpathrobotics.com/robot-visual-teach-and-repeat-software-package/
P. Furgale and T. D. Barfoot, “Visual teach and repeat for long-range rover autonomy,” Journal of Field Robotics, vol. 27, no. 5, pp. 534-560, 2010.
A pose graph map of a linear connection form is constructed (Teach) instead of a two-dimensional (2D) precise map, and then, in a repeat method, a map building process is still needed although being simple, and there is a problem where it is difficult to return when deviating from a map.

### (2) Nomad (University of California, Berkeley)

https://general-navigation-models.github.io/nomad/
A. Sridhar, D. Shah, C. Glossop, and S. Levine, “Nomad: Goal masked diffusion policies for navigation and exploration,” in IEEE International Conference on Robotics and Automation (ICRA), 2024, pp. 63-70.
Only sequential images are stored (goal image) instead of constructing a precise map in a teach process, and then, in a method of repeating sequential images in a repeat step, because of deviating from a path when an additional signal such as GNSS is inaccurate, there is a problem where it is difficult to return, or much time is consumed in returning.

### SUMMARY

In the related art, all of Visual Teach and Repeat and Nomad store only simple path information and use in autonomous driving in preparation for precise map-based navigation.

On the other hand, in Visual Teach and Repeat, an operation of constructing a pose graph map is needed for general use.

Moreover, in Nomad technology, cost is hardly consumed in storing path information, and thus, Nomad is robot self-driving technology which is easily applied to autonomous driving of a guide dog robot which assists a blind person who is a socially weak person. That is, Nomad is technology which is relatively easy to use because it is enough to store only sequential images of a path. However, because Nomad has been mainly tested in an open area where a GNSS signal is relatively accurate, Nomad has not been verified in a complicated environment such as an urban zone where there are many tall buildings, and when the GNSS signal is inaccurate, it is predicted that a problem occurs where it is unable to reach a destination because of deviating from a path.

Therefore, the present disclosure provides a method and a device, which may solve a problem which occurs when conventional self-driving technology is applied to a guide dog robot for blind persons of an urban zone and may solve problems such as path deviation and a reduction in a destination reach success rate.

The object of the present invention is not limited to the aforesaid, but other objects not described herein will be clearly understood by those skilled in the art from descriptions below.

A navigation method according to an embodiment of the present disclosure may be a method performed by a navigation device which includes a storage device configured to store a plurality of waypoint images and a plurality of first movement reference instructions previously generated by using a database, a memory configured to store instructions readable by a computer, and a processor configured to execute the instructions.

The navigation method may include: a step of receiving an observed image; a step of extracting a goal image from among the plurality of waypoint images stored in the database and extracting a second movement reference instruction applied to autonomous driving of a robot from among the plurality of first movement reference instructions stored in the database, based on the observed image; and a step of inputting the observed image, the goal image, and the second movement reference instruction to a pre-trained autonomous driving path generation model to generate an autonomous driving path and motion applied to the robot.

In an embodiment of the present disclosure, each of the plurality of first movement reference instructions may include a movement guideline and a structure of a road on which a user of the robot moves.

In an embodiment of the present disclosure, the user may be a blind person.

In an embodiment of the present disclosure, the plurality of waypoint images and the plurality of first movement reference instructions may be stored in the database in synchronization with each other.

In an embodiment of the present disclosure, the navigation method may further include a step of storing the plurality of waypoint images in the database by using the navigation device. In this case, the step of storing the plurality of waypoint images may include: a step of inputting the plurality of waypoint images to a feature extractor to generate a plurality of waypoint features; and a step of mapping the plurality of waypoint images to the plurality of waypoint features corresponding to the plurality of waypoint images to store a mapped image in the database, based on a same index.

In an embodiment of the present disclosure, the step of extracting the second movement reference instruction may include: a step of inputting the observed image to the feature extractor to generate a query feature; a step of setting an index of a waypoint feature, which is the most similar to the query feature, of the plurality of waypoint features to a Top-1 index; and a step of extracting the goal image and the second movement reference instruction in the database by using the Top-1 index.

In an embodiment of the present disclosure, the step of extracting the goal image and the second movement reference instruction may include a step of adding a look-ahead-step to the Top-1 index to calculate a goal image index and extracting, as the goal image, a waypoint image corresponding to the goal image index from among the plurality of waypoint images.

In an embodiment of the present disclosure, the look-ahead-step may have a value which is greater than 0.

In an embodiment of the present disclosure, the autonomous driving path generation model may include: an artificial neural network configured to receive pieces of multimodal information to generate a feature of each of the pieces of multimodal information; a transformer configured to integrate the features of the pieces of multimodal information by applying a cross attention to generate an attentive feature; and a diffusion model configured to receive the attentive feature to generate the autonomous driving path and motion.

In an embodiment of the present disclosure, the autonomous driving path generation model may include: a first artificial neural network configured to receive the observed image to generate an observed image feature; a second artificial neural network configured to receive the goal image to generate a goal image feature; a third artificial neural network configured to receive the second movement reference instruction to generate a movement reference instruction feature; a transformer configured to integrate the observed image feature, the goal image feature, and the movement reference instruction feature by applying a cross attention to generate an attentive feature; and a diffusion model configured to receive the attentive feature to generate the autonomous driving path and motion.

A navigation device according to an embodiment of the present disclosure may include: a storage device configured to store a plurality of waypoint images and a plurality of first movement reference instructions previously generated by using a database; a processor; and a memory configured to store one or more instructions executed by the processor.

The one or more instructions may include: an instruction of receiving an observed image; an instruction of extracting a goal image from among the plurality of waypoint images and extracting a second movement reference instruction applied to autonomous driving of a robot from among the plurality of first movement reference instructions, based on the observed image; and an instruction of inputting the observed image, the goal image, and the second movement reference instruction to a pre-trained autonomous driving path generation model to generate an autonomous driving path and motion applied to the robot.

In an embodiment of the present disclosure, each of the plurality of first movement reference instructions may include a movement guideline and a structure of a road on which a user of the robot moves.

In an embodiment of the present disclosure, the user may be a blind person.

In an embodiment of the present disclosure, the plurality of waypoint images and the plurality of first movement reference instructions may be stored in the database in synchronization with each other.

In an embodiment of the present disclosure, the one or more instructions may further include an instruction of storing the plurality of waypoint images in the database by using the navigation device. In this case, the instruction of storing the plurality of waypoint images includes: an instruction of inputting the plurality of waypoint images to a feature extractor to generate a plurality of waypoint features; and an instruction of mapping the plurality of waypoint images to the plurality of waypoint features corresponding to the plurality of waypoint images to store a mapped image in the database, based on a same index.

In an embodiment of the present disclosure, the instruction of extracting the second movement reference instruction may include: an instruction of inputting the observed image to the feature extractor to generate a query feature; an instruction of setting an index of a waypoint feature, which is the most similar to the query feature, of the plurality of waypoint features to a Top-1 index; and an instruction of extracting the goal image and the second movement reference instruction in the database by using the Top-1 index.

In an embodiment of the present disclosure, the instruction of extracting the goal image and the second movement reference instruction may include an instruction of adding a look-ahead-step to the Top-1 index to calculate a goal image index and extracting, as the goal image, a waypoint image corresponding to the goal image index from among the plurality of waypoint images.

In an embodiment of the present disclosure, the look-ahead-step may have a value which is greater than 0.

In an embodiment of the present disclosure, the autonomous driving path generation model may include: a first artificial neural network configured to receive the observed image to generate an observed image feature; a second artificial neural network configured to receive the goal image to generate a goal image feature; a third artificial neural network configured to receive the second movement reference instruction to generate a movement reference instruction feature; a transformer configured to integrate the observed image feature, the goal image feature, and the movement reference instruction feature by applying a cross attention to generate an attentive feature; and a diffusion model configured to receive the attentive feature to generate the autonomous driving path and motion.

A robot according to an embodiment of the present disclosure may have a passive driving mode and an autonomous driving mode and may include: an RGB camera; a speech recognizer; and an on-board personal computer (PC).

The RGB camera may generate a plurality of waypoint images respectively corresponding to a plurality of waypoints included in a specific path, in the passive driving mode.

The speech recognizer may convert a speech on a movement guideline and a structure of a road, uttered by a user at the plurality of waypoints, into a text to generate a plurality of first movement reference instructions respectively corresponding to the plurality of waypoints, in the passive driving mode.

The on-board PC may include a storage device, a memory, and a processor.

In the passive driving mode, the on-board PC may store the plurality of waypoint images and the plurality of first movement reference instructions in the storage device in synchronization with each other.

In the autonomous driving mode, the on-board PC may receive an observed image, extract a goal image from among the plurality of waypoint images, based on the observed image, extract a second movement reference instruction applied to autonomous driving of the robot from among the plurality of first movement reference instructions, based on the observed image, and input the observed image, the goal image, and the second movement reference instruction to a pre-trained autonomous driving path generation model to generate an autonomous driving path and motion applied to the robot.

Conventional technology fundamentally uses an image for autonomous driving of a robot and uses global positioning system (GPS) information, a public map service, or a pose graph map which is simpler than a precise map. However, conventional technology does not completely remove and is still vulnerable to a high-rise urban environment.

On the other hand, the present disclosure may add a “movement reference instruction”, provided to a blind person by a guider when rehoming a guide dog, to the blind person, and thus, may enable autonomous driving by using only an image and the movement reference instruction without needing an arbitrary kind of map. Also, the present disclosure may have a feature where path information is easily scanned, and thus, may be applied to autonomous driving of an agricultural robot, a distribution robot, and a patrol robot for performing repeated patrols, in addition to a guide dog robot.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for describing an operating method of a guide dog robot according to an embodiment of the present disclosure.

FIG. 2 is a diagram for describing an operating method of a guide dog robot according to an embodiment of the present disclosure.

FIG. 3 is a block diagram illustrating a configuration of a guide dog robot according to an embodiment of the present disclosure.

FIG. 4 is a diagram illustrating an example of a movement reference instruction and image information obtained by a path scan.

FIG. 5 is a diagram illustrating an example of an autonomous driving path generation model based on multimodal information according to an embodiment of the present disclosure.

FIG. 6 is a diagram for describing a waypoint image search method according to an embodiment of the present disclosure.

FIG. 7 is a flowchart for describing a navigation method according to an embodiment of the present disclosure.

FIG. 8 is a block diagram illustrating a configuration of a navigation device according to an embodiment of the present disclosure.

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts.

In a case where a blind person is rehomed with a guide dog, a guide dog instructor may repeatedly move along a path where the blind person frequently moves a plurality of times together with the guide dog and the blind person. At this time, the guide dog instructor may explain in detail a structure of a road to the blind person.

In the present disclosure, as in the explanation of the guide dog instructor, a structure of a road on which a blind person moves and a movement guideline based thereon may be referred to as a “movement reference instruction”. That is, the movement reference instruction (MRI) may be information about a structure of a road and a movement guideline based thereon. The movement reference instruction may have the form of text or speech data. However, in the present disclosure, a data format of the movement reference instruction is not limited thereto.

An example of a movement reference instruction will be described below.

Example 1) “There is a crosswalk ahead. About 8 m to an opposite pavement. Because a bus stop is on the right, many persons may stand.”

Example 2) “If a guide dog stops in front of a crosswalk, please depart after checking a signal sound.”

Example 3) “Because an opposite sidewalk is slightly narrow, when moving by two or three steps to the left as soon as crossing, it may be possible to go without bumping persons standing at a bus stop.”

A movement reference instruction may be used in autonomous driving (referred to as ‘autonomous walking’) of a guide dog robot according to the present disclosure. That is, like that a blind person explains a structure of a road to a guide dog instructor, in a case where a guide dog robot initially drives along a path (‘Teach’), the guide dog instructor may explain a structure of a road to the robot with speech, and the robot may record and store the explanation. At this time, image information and speech information (movement reference instruction) about a path may be stored in synchronization with each other. Also, the movement reference instruction may be used for the robot to determine a road structure along with the image information when the robot repeats a corresponding path (‘Repeat’).

Table 1 shows a difference between the related art and the present disclosure (‘Ours’). In the present disclosure, user explanation information (movement reference instruction) about a road structure may be used as a very important driving clue in autonomous driving, and particularly, may largely help select a road on a crosswalk.

TABLE 1

Use Information

| | | | | Long Distance |
|---|---|---|---|---|
| Technology | Goal | | Additional | and Crossroad |
| classification | Image | Map | Data | Robustness |
| VTR | ◯ | ◯ | X | ◯ |
| Nomad | ◯ | X | X | X |
| Ours | ◯ | X | User | ◯ |
| | | | Language | |

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limited to example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

While terms such as “first” and “second,” etc., may be used to describe various components, such components must not be understood as being limited to the above terms. It will be understood that when an element is referred to as being “connected to” another element, it can be directly connected to the other element or intervening elements may also be present.

In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Also, other expressions describing relationships between components such as “˜ between”, “immediately ˜ between” or “adjacent to ˜” and “directly adjacent to ˜” may be construed similarly.

In the present disclosure, a ‘neural network’ may denote an ‘artificial neural network’ which is a kind of artificial intelligence model.

In describing embodiments, description on technology which is well known in the technical field of the present invention and is directly irrelevant to the present invention is omitted. This is for more clearly transferring subject matters of the present invention by omitting an unnecessary description in order not to obscure subject matters of the present invention.

The following [1] may be a reference document of the present disclosure. In the present disclosure, the reference document or a methodology proposed in the reference document may be referred to by a number assigned to the reference document.
[1] Seung-Min Choi, Seung-Ik Lee, Jae-Yeong Lee, In So Kweon, “Semantic-guided de-attention with sharpened triplet marginal loss for visual place recognition,” Pattern Recognition, Volume 141, Article 109645, 2023. https://doi.org/10.1016/j.patcog.2023.109645

Hereinafter, embodiments of the invention will be described in detail with reference to the accompanying drawings. In describing the invention, to facilitate the entire understanding of the invention, like numbers refer to like elements throughout the description of the figures, and a repetitive description on the same element is not provided.

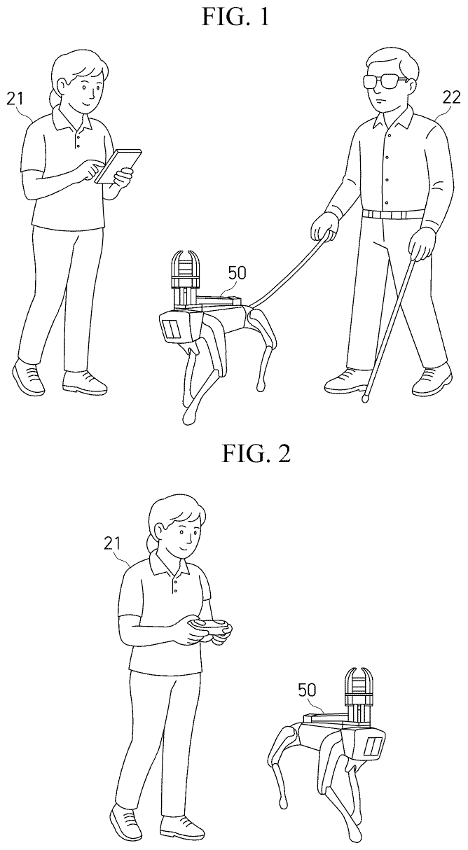

FIG. 1 is a diagram for describing a concept of the present disclosure and is a diagram of an operating method of a guide dog robot according to an embodiment of the present disclosure.

A guide dog instructor 21 may store an image of each point, included in a path where a blind person 22 frequently moves, and a movement reference instruction corresponding to each point in a self-driving guide dog robot 50 (hereinafter referred to as a ‘robot’). Subsequently, the blind person 22 may accompany the robot 50. At this time, the robot 50 may self-drive along a stored path, based on the stored image and movement reference instruction and an image (an observed image) obtained in real time.

The robot 50 may have an autonomous driving mode and a passive driving mode. In the passive driving mode, a user may move the robot 50 by using a joystick. The robot 50 may scan information about a path in the passive driving mode. In the present disclosure, a mode where the robot 50 scans the information about the path may be referred to as a ‘scan mode’.

FIG. 2 illustrates an example where the guide dog instructor 21 moves the robot 50 in the passive driving mode by using the joystick. In the scan mode in the passive driving mode, the guide dog instructor 21 may scan and store an image of a path in moving while moving according to an instruction transferred through the joystick from the guide dog instructor 21.

In the autonomous driving mode, a user may designate a starting point and a destination point of the robot 50 through a terminal of the user, and the robot 50 may self-drive up to the destination point from the starting point by using information (a movement reference instruction and an image of each point included in a path) which is previously scanned and stored.

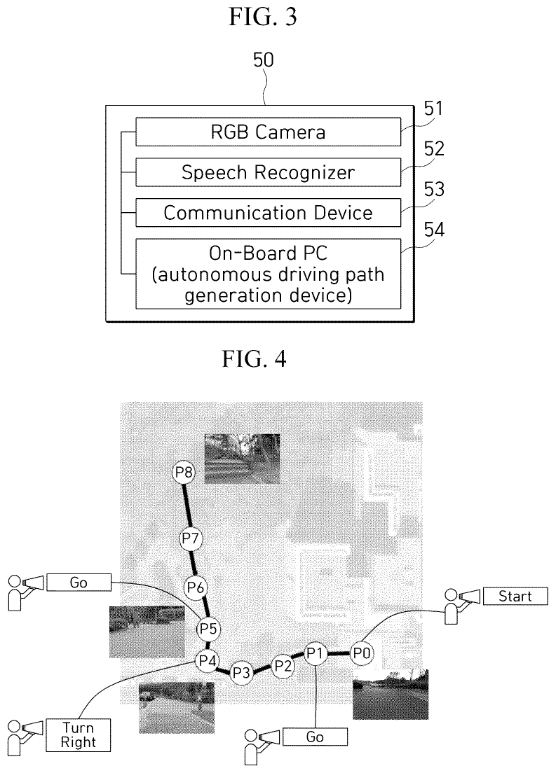

FIG. 3 is a block diagram illustrating a configuration of a guide dog robot according to an embodiment of the present disclosure. As illustrated in FIG. 3, a robot 50 may include an RGB camera 51, a speech recognizer 52, a communication device 53, and an on-board personal computer (PC) 54.

In the present disclosure, the on-board PC 54 included in the robot 50 may be referred to as an ‘autonomous driving path generation device’ or a ‘navigation device’.

The robot 50 illustrated in FIG. 3 may be based on an embodiment of the present disclosure, and the elements of the robot 50 according to an embodiment of the present disclosure is not limited to the embodiment illustrated in FIG. 3 and may be added, modified, or deleted depending on the case. For example, the robot 50 of FIG. 3 may further include a controller, an actuator, a lidar for obstacle detection, a gimbal for preventing shaking, and a depth camera for accurately detecting a position of the blind person 22.

The RGB camera 51 may be provided in plurality and may have various directions, based on performance such as the kind of sensor, a viewing angle, and a resolution. For example, the RGB camera 51 may include a plurality of single-direction (for example, front and rear) cameras, or may include a 360-degree (omnidirectional) camera.

Hereinafter, a path scan process of the robot 50 in the scan mode will be described.

In the scan mode of the robot 50, the guide dog instructor 21 may passively drive the robot 50 up to a destination from a starting point. For example, the communication device 53 of the robot 50 may receive a joystick signal to transfer the joystick signal to the controller of the robot 50, and thus, may allow the robot 50 to passively drive. At this time, the robot 50 may obtain image information (for example, an RGB image) about each point of a path through the RGB camera 51 and may store the image information in synchronization with a movement reference instruction transferred from the guide dog instructor 21. A speech of the guide dog instructor 21 may be converted into a text, and the text may be stored through the speech recognizer 52 of the robot 50.

FIG. 4 is a diagram illustrating an example of a movement reference instruction and image information obtained by a path scan.

The guide dog instructor 21 may transfer, to the robot 50, an appropriate movement reference instruction at each point while moving the robot 50 up to a P8 point from a P0 point. The movement reference instruction may be omitted at a specific point. The robot 50 may obtain image information about each point of a path through a scan, may convert the movement reference instruction (speech), transferred from the guide dog instructor 21, into a text, and may store the image information and the movement reference instruction in synchronization with each other. In FIG. 4, a movement reference instruction and image information about some points are illustrated. Image information about some points such as P1 is omitted in FIG. 4.

For example, the movement reference instruction may represent that ‘Go’, ‘Turn Right’, and ‘Turn Left’ are possible, and a driving direction corresponds to an angle like ‘30 degrees to the left’.

The movement reference instruction based on a speech may be converted into a text by the speech recognizer 52. An utterance start time and an utterance end time of the guide dog instructor 21 may be recorded in a storage device of the on-board PC 54 along with the movement reference instruction.

The speech recognition of the robot 50 may be difficult in a noisy environment due to a sound of a vehicle. In this case, the guide dog instructor 21 may transmit a movement reference instruction such as ‘Go’ and ‘Turn Right/Left’ to the communication device 53 by using a button-type key, and the on-board PC 54 may store the movement reference instruction received by the communication device 53 in synchronization with image information about each point of a movement path. To store the movement reference instruction in the on-board PC 54 of the robot 50 by using the button-type key, for example, when No. 1 button of the button-type key is pressed, ‘Go’ may be stored in a storage device of the on-board PC 54, and when No. 2 button of the button-type key is pressed, ‘Turn Right’ may be stored in the storage device of the on-board PC 54.

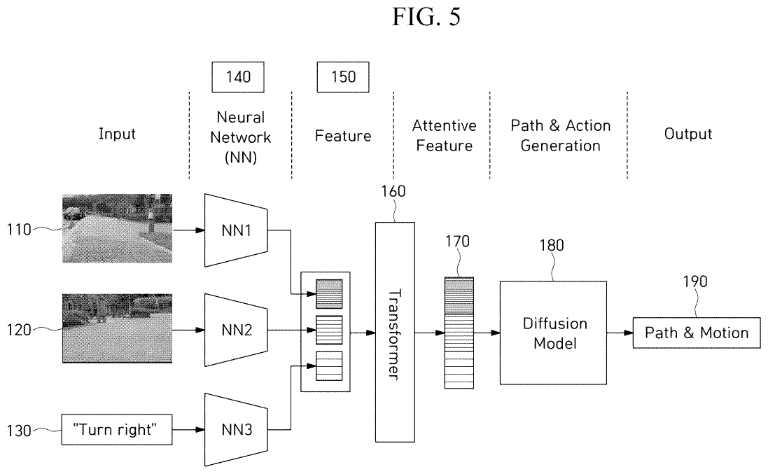

FIG. 5 is a diagram illustrating an example of an autonomous driving path generation model based on multimodal information according to an embodiment of the present disclosure.

The on-board PC 54 may extract a movement reference instruction 130 suitable for a waypoint's goal image 120 (hereinafter referred to as a ‘goal image’) in the storage device, based on an image 110 observed (hereinafter referred to as an ‘observed image’) by the RGB camera 51 with respect to a specific point of a path in autonomous driving.

The goal image 120 and the movement reference instruction 130 may be stored in the scan mode of the robot 50. That is, the goal image 120 may be sequential waypoint's goal images stored in a process where the robot 50 scans a path. In other words, the goal image 120 may be an image of a middle waypoint among waypoints between a staring point and a destination point. Also, the movement reference instruction 130 may be an instruction such as ‘Go’ or ‘Turn Left’ provided for each important waypoint.

The on-board PC 54 may input the observed image 110, the goal image 120, and the movement reference instruction 130 to an autonomous driving path generation model based on pre-learned multimodal information to generate an autonomous driving path and a motion of the robot 50.

As illustrated in FIG. 5, the on-board PC 54 may embed, in a pre-trained neural network 140, each of the observed image 110 at which a robot currently looks, the goal image (waypoint's goal image) 120 sequentially stored in a path scan process, and the movement reference instruction 130 stored for each important waypoint to generate a multimodal feature 150. The multimodal feature 150 may include (not shown) an observed image feature 151, a goal image feature 152, and a movement reference instruction feature 153. Also, the on-board PC 54 may input the multimodal feature 150 to a transformer 160 and may integrate the features 151 to 153 by applying a cross attention, and thus, may generate an attentive feature 170. The on-board PC 54 may input the attentive feature 170 to a pre-trained diffusion model 180 to generate an autonomous driving path and motion 190 of the robot 50 and may transfer the autonomous driving path and motion 190 to the controller of the robot 50. The controller of the robot 50 may control the robot 50 to self-drive in a destination direction, based on the autonomous driving path and motion 190 generated by the method described above.

The related art may be applied to the neural network 140, the transformer 160, and the diffusion model 180 included in the autonomous driving path generation model of FIG. 5.

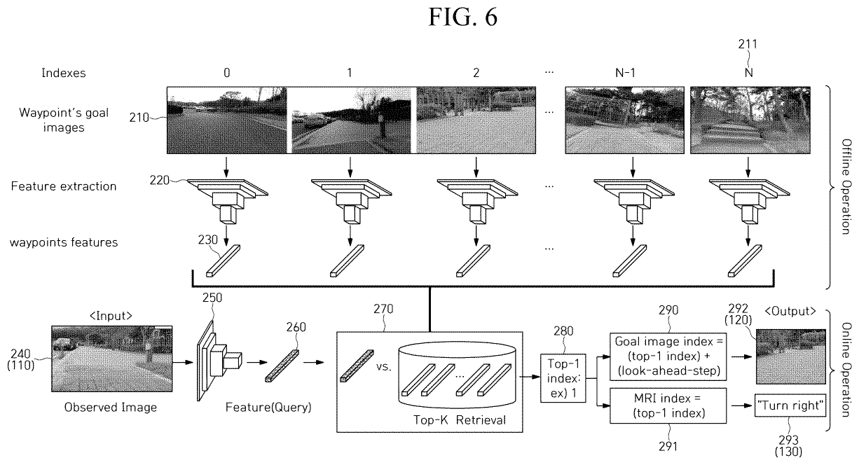

FIG. 6 is a diagram for describing a waypoint image search method according to an embodiment of the present disclosure.

In the description of the embodiment of FIG. 5, it has been described that the on-board PC 54 extracts the goal image 120 and the movement reference instruction 130, based on the observed image 110 of a specific point of a path. FIG. 6 is a diagram for describing a method of extracting the goal image 120 and the movement reference instruction 130, based on the observed image 110.

The goal image 120 may be an image of a waypoint between a starting point and a destination point and may be an image of a destination which is a middle movement target of the robot 50. With reference to FIG. 6, a method of selecting the goal image 120 and the movement reference instruction 130 of FIG. 5 may be described.

Generally, visual place recognition technology based on image search may set a query when a currently observed image is input, may search for waypoint images stored in a database to detect an image which is the most similar to the observed image, and may use the detected image as a goal image. Such a method may be applied to conventional ‘Teach and Replay’ and ‘Nomad’.

However, in a case which detects a top-1 image, which is the most similar to the currently observed image, from among the waypoint images, sets the top-1 image to a goal image, and applies a method of following the goal image to autonomous driving based on a movement reference instruction, two problems occur.

First, when an observed image is close to a waypoint image, a rapid turn path may be generated, and thus, a zigzag pattern may occur in a robot motion (hereinafter referred to as a ‘first problem’).

Second, a movement reference instruction according to an embodiment of the present disclosure may function as current and near future driving policy, and thus, a goal image should be a destination of the near future including a current image.

In the embodiment of FIG. 5, it may be assumed that ‘Turn right’ is input as a movement reference instruction 130 to NN3 of a neural network 140, and instead of the goal image 120 illustrated in FIG. 5, an image of a point similar to the current observed image 110 is input to NN2 of the neural network 140. In this case, a possibility that the autonomous driving path generation model interprets a context of an image as “Go” may be high, and thus, it may be difficult to predict an arbitrary path corresponding to an autonomous driving path generated by the diffusion model 180 among “Go” and “Turn right” (hereinafter referred to as a ‘second problem’).

On the other hand, as in the embodiment of FIG. 5, when an image after “Turn right” is input as the goal image 120 to NN2, a possibility that a context of an image interpreted by the autonomous driving path generation model is interpreted as a path for turning right at a point corresponding to the current observed image 110 may be high. Accordingly, even when “Turn right” is input as the movement reference instruction 130 to NN3, the image information 110 and 120 may not collide with the movement reference instruction 130, and thus, a correct path where the robot 50 turns right may be inferred by the diffusion model 180.

An embodiment of a method of extracting a goal image and a movement reference instruction illustrated in FIG. 6 may be designed with reference to the reference document [1]. The reference document [1] correspond to one of the latest methods in visual place recognition technology based on a deep feature. A featural component of the embodiment of FIG. 6 may be a block 290, and thus, may solve two problems described above, based on the block 290.

Hereinafter, a method of extracting a goal image which is a waypoint image, based on an observed image, will be described with reference to FIG. 6. For reference, an observed image 240, a goal image 292, and a movement reference instruction 293 of FIG. 6 may respectively correspond to the observed image 110, the goal image 120, and the movement reference instruction 130 of FIG. 5.

The method of extracting a goal image and a movement reference instruction illustrated in FIG. 6 may be classified into an offline operation and an online operation. The offline operation may be a pre-operation which is performed only once when a movement path of the robot 50 is designed. Also, the online operation may be an operation which is repeatedly executed in the middle of autonomous driving of the robot 50.

First, the on-board PC 54 may input a sequential plurality of waypoint goal images 210 (hereinafter referred to as a waypoint image), obtained through a path scan (see FIG. 4), to a first feature extractor 220 to convert into a waypoint feature 230 and may store the waypoint feature 230 in a database of a storage device of the on-board PC 54. That is, each of the waypoint images 210 may be converted into a deep feature vector and may be stored in the database. Such a process may be executed off-line only once when a path is fixed. The waypoint feature 230 corresponding to the waypoint image 210 may have the same index 211 and may be stored in the database of the storage device of the on-board PC 54.

For example, the first feature extractor 220 may be constructed based on a transformer including an attention function and/or a CNN deep learning model such as ResNet or MobileNet. In a case where the first feature extractor 220 is provided in plurality, each feature extractor may have the same parameter value and the same neural network structure. It may be preferable that a second feature extractor 250 is the same module as the first feature extractor 220. That is, the second feature extractor 250 may have the same neural network structure and parameter value as those of the first feature extractor 220.

As described above with reference to FIG. 5, when the current observed image 110 is input, the goal image 120 and the movement reference instruction 130 may be decided through the method of FIG. 6.

In FIG. 6, an offline operation may be executed on a specific path only once, and an online operation may be continuously executed based on obtainment of the observed image 240.

As illustrated in FIG. 6, the on-board PC 54 may input the observed image 240, generated as a current observation result, to the second feature extractor 250 to generate a query feature 260.

In an embodiment of the present disclosure, each of the waypoint feature 230 and the query feature 260 may be a deep feature vector, and the on-board PC 54 may compare one query feature 260 with a plurality of waypoint features 230 by using a searcher 270 to extract an index 280 (hereinafter referred to as a ‘Top-1 index’) of the most similar waypoint feature 230 in the database. Accordingly, the Top-1 index 280 may correspond to an index of a waypoint image 210 which is the most similar to the observed image 240.

The on-board PC 54 may substitute the Top-1 index 280 into an MRI index 291 which is an index of a movement reference instruction. That is, the on-board PC 54 may set the Top-1 index 280 to the index of the movement reference instruction. The on-board PC 54 may extract the movement reference instruction 293 corresponding to the MRI index 291 in the database. That is, the on-board PC 54 may obtain the movement reference instruction 293 (for example, ‘Turn right’) synchronized with the waypoint image 210 which is the most similar to the observed image 240.

Moreover, the on-board PC 54 may set a value, obtained by adding a certain look-ahead-step to the Top-1 index 280, to an index of the goal image 292. As described above, the block 290 of FIG. 6 may be introduced for solving a first problem and a second problem and may extend a viewpoint of the goal image 292 by using an appropriate look-ahead-step, and thus, an effect of matching a context of an introduction movement reference instruction 293 with a context of the goal image 292 may be expected. Accordingly, a look-ahead-step may be set to a value which is greater than 0.

For example, when a period of an index 211 of the waypoint image 210 is 1 second (where this may denote that a waypoint image is stored once per 1 second when scanning a path), and a value of a look-ahead-step is set to 3, the on-board PC 54 may select, as the goal image 292, a waypoint image 210 after 3 seconds from a current position, and the robot 50 may follow the selected goal image 292.

On the other hand, when a look-ahead-step is 0, the robot 50 may follow a waypoint image 210 corresponding to the Top-1 index 280. In a Go path, the on-board PC 54 may generate a stable path where zigzag is small, based on an appropriate look-ahead-step value. Also, in a case where the robot 50 performs turn driving, the on-board PC 54 may generate a smooth path, based on the appropriate look-ahead-step value. The appropriate look-ahead-step value should be obtained through an experiment, but it may be possible to generate a stable path through introduction of the value.

A look-ahead-step may be set or changed with respect to a collection period of the waypoint image 210 and/or a driving speed of the robot 50 (which may be set based on a walking speed of the blind person 22) in the scan mode of the robot 50. For example, as the collection period of the waypoint image 210 of the robot 50 is shortened, the look-ahead-step may increase. Also, as the driving speed of the robot 50 decreases, the look-ahead-step may increase.

The observed image 240 which is an input of the embodiment of FIG. 6 and the goal image 292 and the movement reference instruction 293 which are outputs of the embodiment of FIG. 6 may be respectively associated with the observed image 110, the goal image 120, and the movement reference instruction 130 in the embodiment of FIG. 5.

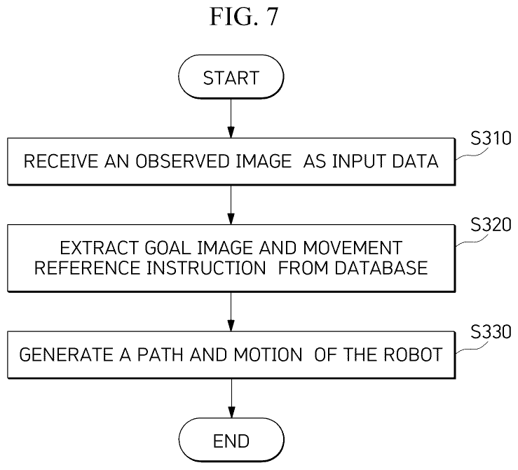

FIG. 7 is a flowchart for describing a navigation method according to an embodiment of the present disclosure. Under a condition where a path scan process of FIG. 4 has been performed, the methods of FIGS. 5 and 6 may be briefly described with reference to the flowchart of FIG. 7.

As illustrated in FIG. 7, a navigation method based on multimodal information (hereinafter referred to as a ‘navigation method’) according to an embodiment of the present disclosure may include steps S310 to S330. The navigation method illustrated in FIG. 7 may be based on an embodiment of the present disclosure, and the steps of the navigation method according to an embodiment of the present disclosure is not limited to the embodiment illustrated in FIG. 7 and may be added, modified, or deleted depending on the case.

Step S310 may be a step of receiving an observed image.

The on-board PC 54 may receive the observed images 110 and 240 from the RGB camera 51.

Step S320 may be a step of extracting a goal image and a movement reference instruction in the database. In step S320, the on-board PC 54 may extract the goal images 120 and 292 and the movement reference instructions 130 and 293 in the database, based on the observed images 110 and 240.

In detail, the on-board PC 54 may input the observed images 110 and 240 to the feature extractor 250 to generate the query feature 260 and may set, to the Top-1 index 280, an index 211 of a waypoint feature 230 the most similar to the query feature 260 among a plurality of waypoint features 230 which are previously stored. Also, the on-board PC 54 may extract the goal images 120 and 292 and the movement reference instructions 130 and 293 by using the Top-1 index 280. In detail, the on-board PC 54 may add a certain look-ahead-step to the Top-1 index 280 to calculate indexes of the goal images 120 and 292, and then, may extract the goal images 120 and 292 corresponding to the calculated indexes of the goal images 120 and 292 in the database. Also, the on-board PC 54 may extract the movement reference instructions 130 and 293 corresponding to the Top-1 index 280 in the database.

Step S330 may be a step of generating a path and a motion of the robot.

The on-board PC 54 may input the observed images 110 and 240, received in step S310, and the goal images 292 and 120 and the movement reference instructions 293 and 130, extracted in step S320, to a pre-trained autonomous driving path generation model to generate the autonomous driving path and motion 190 of the robot 50.

The navigation method described above has been described with reference to the flowchart illustrated in the drawing. To provide a simple description, the method is illustrated as a series of blocks and has been described, but the present disclosure is not limited to the order of the blocks, and some blocks and the other blocks may be executed simultaneously or in order which differs from the illustration and description of the present disclosure, and various other branches and flow paths and the orders of blocks for accomplishing the same or similar results may be implemented. Also, all blocks illustrated for implementing the method described in the present disclosure may not be needed.

In the above description of FIG. 7, based on an implementation example of the present disclosure, each step may be further divided into additional steps, or may be combined into fewer steps. Also, depending on the case, some steps may be omitted, and the order of steps may be changed. Despite other omitted descriptions, the descriptions of FIGS. 1 to 6 may be applied to the description of FIG. 7. Also, the descriptions of FIGS. 4 to 7 may be applied to the description of FIG. 3.

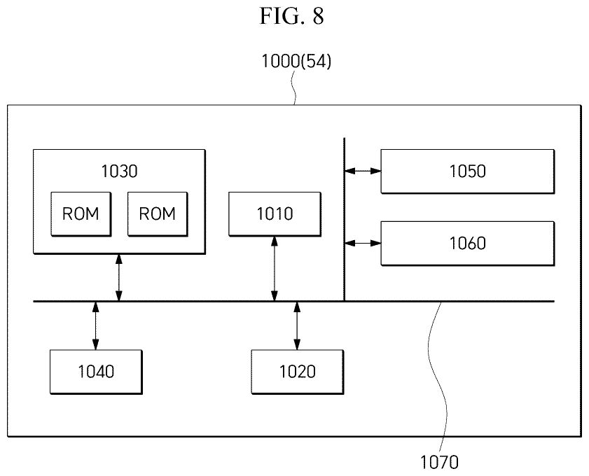

FIG. 8 is a block diagram illustrating a configuration of a navigation device 1000 according to an embodiment of the present disclosure. The navigation device 1000 may be equipped in the robot 50 and may operate as the on-board PC 54, or may be a separate device which performs a function of the on-board PC 54 with being connected to the robot 50 through wireless communication and physically separated from the robot 50.

The navigation device 1000 may be a type of computer system as illustrated in FIG. 8.

Referring to FIG. 8, the navigation device 1000 may include at least one of at least one processor 1010, a memory 1030, an input interface device 1050, an output interface device 1060, and a storage device 1040, which communicate with each other through a bus 1070. The navigation device 1000 may further include a communication device 1020 coupled to a network. The processor 1010 may be central processing unit (CPU), or may be a semiconductor device which executes instructions stored in the memory 1030 and/or the storage device 1040. The memory 1030 and the storage device 1040 may each include various types of volatile or non-volatile storage mediums. For example, the memory 1030 may include read-only memory (ROM) and random access memory (RAM). In an embodiment of the present disclosure, the memory 1030 may be disposed in or outside the processor 1010 and may be connected to the processor 1010 through various means well known. The memory 1030 may include various types of volatile or non-volatile storage mediums, and for example, may include ROM and RAM.

Therefore, an embodiment of the present disclosure may be implemented as a method implemented in a computer, or may be implemented as a non-transitory computer-readable medium storing an instruction executable by a computer. In an embodiment of the present disclosure, when executed by the processor 1010, computer-readable instructions may perform the method according to at least one aspect of the present disclosure.

The communication device 1020 may transmit or receive a wired signal or a wireless signal.

Moreover, the navigation method according to embodiments of the present disclosure may be implemented in the form of program instructions capable of being executed through various computer means and may be recorded in a computer-readable recording medium.

The computer-readable recording medium may individually include a program instruction, a data file, and a data structure, or may include a combination thereof. The program instruction recorded in the computer-readable medium may be specially designed and configured for embodiments of the present disclosure, or may be known to those skilled in the art in the field of computer software and may be available. The computer-readable recording medium may include a hardware device configured to store and execute a program instruction. For example, the computer-readable recording medium may include a magnetic storage medium such as a hard disk, a floppy disk, and a magnetic tape, an optical recording medium such as CD-ROM and digital versatile disk (DVD), read-only memory (ROM), random access memory (RAM), and flash memory. The program instruction may include a machine language code, such as being created by a compiler, and a high-level language code capable of being executed by a computer through an interpreter.

The processor 1010 may execute computer-readable instructions stored in the memory 1030 or the storage device 1040, and thus, may perform the navigation method described above with reference to FIGS. 4 to 7.

Conventional technology fundamentally uses an image for autonomous driving of a robot and uses global positioning system (GPS) information, a public map service, or a pose graph map which is simpler than a precise map. However, conventional technology does not completely remove and is still vulnerable to a high-rise urban environment.

On the other hand, the present disclosure may add a “movement reference instruction”, provided to a blind person by a guider when rehoming a guide dog, to the blind person, and thus, may enable autonomous driving by using only an image and the movement reference instruction without needing an arbitrary kind of map. Also, the present disclosure may have a feature where path information is easily scanned, and thus, may be applied to autonomous driving of an agricultural robot, a distribution robot, and a patrol robot for performing repeated patrols, in addition to a guide dog robot.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A navigation method performed by a navigation device including a storage device configured to store a plurality of waypoint images and a plurality of first movement reference instructions previously generated by using a database, a memory configured to store instructions readable by a computer, and a processor configured to execute the instructions, the navigation method comprising:
a step of receiving an observed image;
a step of extracting a goal image from among the plurality of waypoint images stored in the database and extracting a second movement reference instruction applied to autonomous driving of a robot from among the plurality of first movement reference instructions stored in the database, based on the observed image; and
a step of inputting the observed image, the goal image, and the second movement reference instruction to a pre-trained autonomous driving path generation model to generate an autonomous driving path and motion applied to the robot.

2. The navigation method of claim 1, wherein each of the plurality of first movement reference instructions comprises a movement guideline and a structure of a road on which a user of the robot moves.

3. The navigation method of claim 2, wherein the user is a blind person.

4. The navigation method of claim 1, wherein the plurality of waypoint images and the plurality of first movement reference instructions are stored in the database in synchronization with each other.

5. The navigation method of claim 1, further comprising a step of storing the plurality of waypoint images in the database by using the navigation device,
wherein the step of storing the plurality of waypoint images comprises:
a step of inputting the plurality of waypoint images to a feature extractor to generate a plurality of waypoint features; and
a step of mapping the plurality of waypoint images to the plurality of waypoint features corresponding to the plurality of waypoint images to store a mapped image in the database, based on a same index.

6. The navigation method of claim 5, wherein the step of extracting the second movement reference instruction comprises:
a step of inputting the observed image to the feature extractor to generate a query feature;
a step of setting an index of a waypoint feature, which is the most similar to the query feature, of the plurality of waypoint features to a Top-1 index; and
a step of extracting the goal image and the second movement reference instruction in the database by using the Top-1 index.

7. The navigation method of claim 6, wherein the step of extracting the goal image and the second movement reference instruction comprises a step of adding a look-ahead-step to the Top-1 index to calculate a goal image index and extracting, as the goal image, a waypoint image corresponding to the goal image index from among the plurality of waypoint images.

8. The navigation method of claim 7, wherein the look-ahead-step has a value which is greater than 0.

9. The navigation method of claim 1, wherein the autonomous driving path generation model comprises:
an artificial neural network configured to receive pieces of multimodal information to generate a feature of each of the pieces of multimodal information;
a transformer configured to integrate the features of the pieces of multimodal information by applying a cross attention to generate an attentive feature; and
a diffusion model configured to receive the attentive feature to generate the autonomous driving path and motion.

10. The navigation method of claim 1, wherein the autonomous driving path generation model comprises:
a first artificial neural network configured to receive the observed image to generate an observed image feature;
a second artificial neural network configured to receive the goal image to generate a goal image feature;
a third artificial neural network configured to receive the second movement reference instruction to generate a movement reference instruction feature;
a transformer configured to integrate the observed image feature, the goal image feature, and the movement reference instruction feature by applying a cross attention to generate an attentive feature; and
a diffusion model configured to receive the attentive feature to generate the autonomous driving path and motion.

11. A navigation device comprising:
a storage device configured to store a plurality of waypoint images and a plurality of first movement reference instructions previously generated by using a database;
a processor; and
a memory configured to store one or more instructions executed by the processor,
wherein the one or more instructions comprise:
an instruction of receiving an observed image;
an instruction of extracting a goal image from among the plurality of waypoint images and extracting a second movement reference instruction applied to autonomous driving of a robot from among the plurality of first movement reference instructions, based on the observed image; and
an instruction of inputting the observed image, the goal image, and the second movement reference instruction to a pre-trained autonomous driving path generation model to generate an autonomous driving path and motion applied to the robot.

12. The navigation device of claim 11, wherein each of the plurality of first movement reference instructions comprises a movement guideline and a structure of a road on which a user of the robot moves.

13. The navigation device of claim 12, wherein the user is a blind person.

14. The navigation device of claim 11, wherein the plurality of waypoint images and the plurality of first movement reference instructions are stored in the database in synchronization with each other.

15. The navigation device of claim 11, wherein the one or more instructions further comprise an instruction of storing the plurality of waypoint images in the database by using the navigation device,
wherein the instruction of storing the plurality of waypoint images comprises:
an instruction of inputting the plurality of waypoint images to a feature extractor to generate a plurality of waypoint features; and
an instruction of mapping the plurality of waypoint images to the plurality of waypoint features corresponding to the plurality of waypoint images to store a mapped image in the database, based on a same index.

16. The navigation device of claim 15, wherein the instruction of extracting the second movement reference instruction comprises:
an instruction of inputting the observed image to the feature extractor to generate a query feature;
an instruction of setting an index of a waypoint feature, which is the most similar to the query feature, of the plurality of waypoint features to a Top-1 index; and
an instruction of extracting the goal image and the second movement reference instruction in the database by using the Top-1 index.

17. The navigation device of claim 16, wherein the instruction of extracting the goal image and the second movement reference instruction comprises an instruction of adding a look-ahead-step to the Top-1 index to calculate a goal image index and extracting, as the goal image, a waypoint image corresponding to the goal image index from among the plurality of waypoint images.

18. The navigation device of claim 17, wherein the look-ahead-step has a value which is greater than 0.

19. The navigation device of claim 11, wherein the autonomous driving path generation model comprises:
a first artificial neural network configured to receive the observed image to generate an observed image feature;
a second artificial neural network configured to receive the goal image to generate a goal image feature;
a third artificial neural network configured to receive the second movement reference instruction to generate a movement reference instruction feature;
a transformer configured to integrate the observed image feature, the goal image feature, and the movement reference instruction feature by applying a cross attention to generate an attentive feature; and
a diffusion model configured to receive the attentive feature to generate the autonomous driving path and motion.

20. A robot having a passive driving mode and an autonomous driving mode, the robot comprising:
an RGB camera;
a speech recognizer; and
an on-board personal computer (PC),
wherein the RGB camera generates a plurality of waypoint images respectively corresponding to a plurality of waypoints included in a specific path in the passive driving mode,
the speech recognizer converts a speech on a movement guideline and a structure of a road, uttered by a user at the plurality of waypoints, into a text to generate a plurality of first movement reference instructions respectively corresponding to the plurality of waypoints in the passive driving mode,
the on-board PC comprises a storage device, a memory, and a processor,
in the passive driving mode, the on-board PC stores the plurality of waypoint images and the plurality of first movement reference instructions in the storage device in synchronization with each other, and
in the autonomous driving mode, the on-board PC receives an observed image, extracts a goal image from among the plurality of waypoint images, based on the observed image, extracts a second movement reference instruction applied to autonomous driving of the robot from among the plurality of first movement reference instructions, based on the observed image, and inputs the observed image, the goal image, and the second movement reference instruction to a pre-trained autonomous driving path generation model to generate an autonomous driving path and motion applied to the robot.
